(19) United States
(12) Patent Application Publication
(10) Pub. No.: US 2003/0105649 A1
(43) Pub. Date: Jun. 5, 2003

(54) Automated data reporting system and method

(76) Inventors: Seth Sheiner, Denver, CO (US); James E. McDonald, Pflugerville, TX (US)

Correspondence Address: Paul W. Fulbright, Strasburger & Price, L.L.P., Suite 3400, 901 Main Street, Dallas, TX, 75202-3794, US

(21) Appl. No.: 09/964,222

(22) Filed: Sep. 26, 2001

Related U.S. Application Data
(60) Provisional application No. 60/236,021, filed on Sep. 27, 2000.

(51) Int. Cl. G06F 17/60; G06F 7/00; G06F 17/00; G06F 15/16

(52) U.S. Cl. 705/2; 707/104.1; 709/217

(57) ABSTRACT

An automated data reporting system collects, stores, analyzes, and reports health related data. The system includes a processor, a memory device coupled to the processor, a communication device coupled to the processor and the memory device, that enables communication via the communication network, a relational database that is stored and updated in the memory device, and an application program that is executed by the processor from the memory device. The application program includes first code, responsive to a query from a provider device via the communication device that instructs the communication device to send a data entry form to the provider device, second code, responsive to receiving a completed data entry form from the provider device, that stores data from the data entry form into the database, third code, responsive to receiving the completed data entry form from the provider device, that notifies a healthcare provider communication device of errors, and fourth code that instructs said communication device to transmit a summary of said data to a receiving agency.

This application claims the benefit of U.S. Provisional Application No. 60/236,021, filed Sep. 27, 2000.

### FIELD OF THE INVENTION

The invention generally relates to interactive and automated reporting of data and, more particularly, relates to systems and methods for collection, analysis, and reporting of health related data, such as trauma patient information, over a network, such as the Internet.

### BACKGROUND OF THE INVENTION

The dissemination of information is prolific in our society. Information technology, particularly the Internet, allows access to huge amounts and wide variety of information. Conventional data reporting, collection, analysis and manipulation schemes are continually being updated through automation. New systems and methods for such automation provide significant advantage and improvement.

In healthcare reporting, particularly of trauma data, conventional systems and methods have been either not automated or only minimally automated. For example, in the case of trauma data reporting, an agency, such as the Texas Department of Health (TDH) in the State of Texas, may collect health related information, such as information on trauma patients and incidents, as well as various diseases. The agency, in such instance, sets up a central repository for records. Trauma case providers provide information to the repository, typically by written reporting and mail delivery. Providers may then be allowed access to the information, or compilations of it, and must obtain the access through the particular repository or agency. The information is available typically by in-person access to written records.

This conventional process can be inefficient. Significant human involvement is required in receiving, storing, and analyzing data. Furthermore, mistakes and errors can occur because of the human involvement. Moreover, the conventional process is accomplished without any significant interaction among and between providers, reporting facilities, and centralized public health agencies.

In an exemplary trauma reporting system in the State of Texas, the Texas Department of Health divides the state into regions. More specifically, TDH divides the State of Texas into twenty-two regions for trauma management. Each region acts within the auspices of a Regional Advisory Council (RAC) for the region, established by the TDH, which has responsibility to maintain quality healthcare management and comprehensive reporting to the state regarding the respective region's trauma care and activities. The RAC receives trauma data from providers, such as emergency medical services (EMS), emergency rooms, hospitals and others. The RAC, collects the health related data and forwards it to the state agency. The RAC also receives various information from the state agency.

Typically, the trading of information in such health data reporting is accomplished by hand delivery, the mail, or in certain instances, limited proprietary point-to-point electronic connection. There are presently several Internet-enabled health websites; however, these sites only allow a remote viewer of the site to view information on the site and, to a limited extent, communicate information to the website host. The remote viewer cannot submit any significant quantities of health data and there is not any mechanism for collection, accumulation, and further reporting or submission of the data, such as submissions to state health departments and others.

Because of the substantial importance of health related data to public health policies and practices, it would be advantageous and a significant improvement in the art and technology to provide systems and methods for real time communications of such information among providers, councils and agencies, as well as others, and to restrict and provide for select accessibility of the information among those allowed access.

### BRIEF SUMMARY OF THE INVENTION

An embodiment of the invention is a method for reporting health related data over a communication network. The method includes steps of accessing a server device of the communication network, providing to a provider device a uniform format for entering the data, receiving the data from the provider device, and storing the data.

Another embodiment of the invention is a method for trauma data reporting over a communication network. The communication network is the Internet. The method includes steps of providing a database. The database serves to relate queries with preprogrammed responses in the form of data entry forms and stores information entered into the data entry form. The method also includes steps of delivering a query to the database over the communication network, accessing an interactive graphical interface relevant to the queries, inputting data, and storing the data in the database.

Yet another embodiment of the invention is a system for the collection, storage, analysis, and reporting of health related data. The system includes a processor, a memory device coupled to the processor, a communication device coupled to the processor and the memory device, that enables communication via the communication network, a relational database that is stored and updated in the memory device, and an application program that is executed by the processor from the memory device. The application program includes first code, responsive to a query from a provider device via the communication device that instructs the communication device to send a data entry form to the provider device, second code, responsive to receiving a completed data entry form from the provider device, that stores data from the data entry form into the database, third code, responsive to receiving the completed data entry form from the provider device, that notifies healthcare provider communication device of errors, and fourth code that instructs said communication device to transmit a summary of said data to a receiving agency.

### BRIEF DESCRIPTION OF THE SEVERAL VIEWS OF THE DRAWINGS

FIG. 1 is a system for automated data reporting.

FIG. 2 is a flow chart of a method of provider device reporting of data, performed by the system of FIG. 1.

FIG. 3 is a flow chart of a method of receiver device accessing of reported data (or portions or compilations thereof), performed by the system of FIG. 1.

FIG. 4 is a flow chart of a method of server receipt and service of reported data, performed by the system of FIG. 1.

FIGS. 5a-c are exemplary Internet web pages served up by the server of the system of FIG. 1, for viewing and input by provider devices, receiver devices, and third party devices.

### DETAILED DESCRIPTION OF THE INVENTION

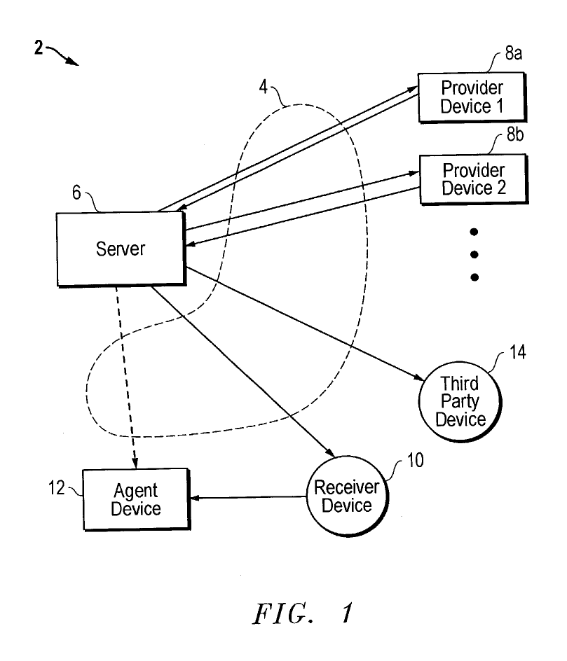

Referring to FIG. 1, a system 2 for automated data reporting includes a communications network 4, such as the Internet. The communications network 4 includes various server and client devices, interconnected for communication over wire, wireless, other communications channel, or combinations thereof. Within the network 4, a server 6, for example a server computer, is connected with various other computing and communication devices. The server 6 maintains, either on the server 6 or associated with the server 6 for access through the server 6, a database of information, for example, trauma event data. The database is, for example, an Oracle, SQL, or other conventional relational database capable of storing data and yielding appropriate responses to queries.

The other computing and communications devices connected to the server 6 include, for example, at least one provider device 8a, 8b and, a receiver device 10. The provider device 8a, 8b is electronic communications equipment capable of communicating with the server 6 over the network 4. The provider device 8a, 8b is, for example, a computer, an Internet-enabled telephone, a personal digital assistant (PDA), or some other similar device capable of communicating either over wireline, wireless, other channel, or combinations of channels. The receiver device 10 is a similar communications device, for example, a personal computer or mainframe computer. The network 4, and communications among the server 6, the provider device 8a, 8b, and the receiver device 10, can be formatted to communicate according to any of a variety of communications protocols; however, if the network 4 is the Internet, then the devices will most likely comply with the transmission control protocol/Internet protocol (TCP/IP) or some similar variant and communicated information can take the form of web pages, such as those conforming to HTML or XML standards.

Also included within the network 4 can be various other network communications devices, such as at least one third party device 14 and at least one agent device 12. The third party device 14 is representative of any of a multitude of available devices that can communicate over the network 4 with the server 6. The third party device 14 is able to receive and display to a user various information made available to the third party device 14 by the server 6, over the network 4. The third party device 14 is allowed limited access to information saved at or in connection with the server 6, as dictated by the server 6 and the security implementations desired by the operator of the server 6.

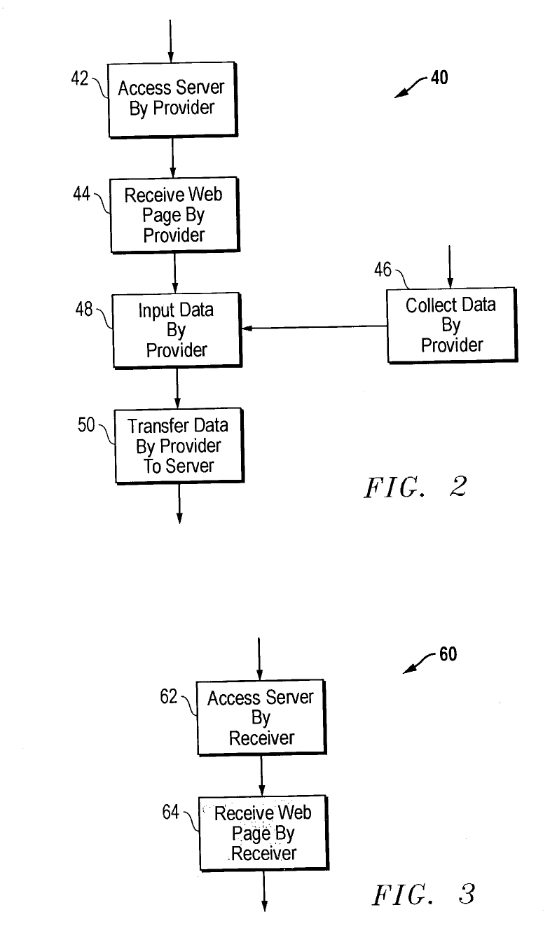

The agent device 12 communicates with the receiver device 10 or, alternatively, communicates with the server 6. The agent device 12 communicates with the server 6 over the network 4 and, alternatively or additionally, communicates with the receiver device 10 over the network 4 or over a point-to-point or other proprietary communication connection between the agent device 12 and the receiver device 10. The agent device 12 is able to view information made available to it by the receiver device 10 or the server 6, as the case may be. The available information to the agent device 12 is determined by the restrictions and security mechanisms of the server 6 and the receiver device 10, as well as the particular communications channel and limitations between the agent device 12 and the server 6 or the receiver device 10, as the case may be. Referring to FIG. 2, a method 40 of operation of the provider device 8a, 8b (shown in FIG. 1) commences with a step 42. In the step 42, the provider device 8a, 8b accesses the server 6 by initiating communications under the particular protocol, such as TCP/IP. The step of accessing 42 occurs via communications over the network 4 between the provider device 8a, 8b and the server 6.

In a step 44, the provider device 8a, 8b receives information, for example, an Internet web page, served to the provider device 8a, 8b over the network 4. The information received by the provider device 8a, 8b in the step 44 is stored on the server 6. After the provider device 8a, 8b accesses the server 6 in the step 42, the provider device 8a, 8b and the server 6 continue communications according to the protocol of the network 4. In the case where the protocol is TCP/IP and the information being served is a web page, the provider device 8a, 8b receives the information and displays it to a user of the provider device 8a, 8b.

At the provider device 8a, 8b, the user inputs data in a step 48. This input of data in the step 48 can, for example, include trauma patient information, patient condition parameters and measurements, and other trauma statistics and data. The data is input in the step 48 directly to the provider device 8a, 8b by the user, either into an active web page, text form, or other form or format. The form or format of the data entry in the step 48 is, in any event, dictated by the programmed requirements for such data, so that the data can be received and manipulated by the server 6.

In connection with the step 48 of inputting data by the provider device 8a, 8b, the user of the provider device 8a, 8b must collect the particular data in a step 46. The data is collected in the step 46 in conventional manner, such as by a human healthcare treatment doctor or other provider after performing conventional medical tests on a patient and making appropriate health condition observations. In the case of trauma registry, the conventional manners of collection include all conventional medical procedures administered to trauma patients to detect physical characteristics of the patient and to provide early and emergency trauma treatments.

In a step 50, the data input by the provider device 8a, 8b is transferred by the provider device 8a, 8b to the server 6. The data is transferred in the step 50 according to the communications protocols of the network 4.

Referring to FIG. 3, a method 60 of operation of the receiver device 10 (shown in FIG. 1) commences with a step 62. In the step 62, the receiver device 10 accesses the server 6 over the network 4. This accessing communication of the receiver device 10 to the server 6 proceeds according to protocols of the network 4. The receiver device 10 can access the same or, most likely, portions of the information or even different information from the server 6, than the information that is so accessible to the provider device 8a, 8b. In particular, the receiver device 10 can be restricted to only receive information from the server 6, rather than permitted to input information to the server 6 for storage. Furthermore, the information available to the receiver device 10 can be a subset or compilation of information at the server 6, as dictated by the programming of the server 6.

In the case of a trauma registry, the server 6 maintains trauma data provided by the various provider devices 8a, 8b. This information is saved in the server 6 database. The database is equipped to search and perform data manipulations and compilations, again according to the programming at the server 6. The receiver device 10, through security and restrictive mechanisms at the server 6, is able to receive in the step 64 various information from the server 6 that the server 6 wishes to make available to the receiver device 10. The information made available to the receiver device 10 can take the form of an Internet web page or other format. The web page or other format is displayed by the receiver device 10 for viewing by a user of the device 10.

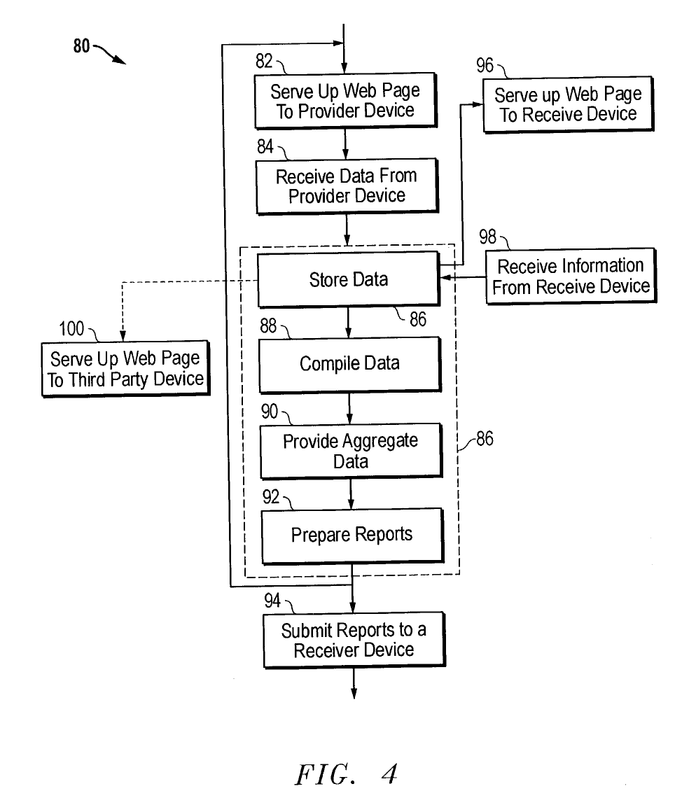

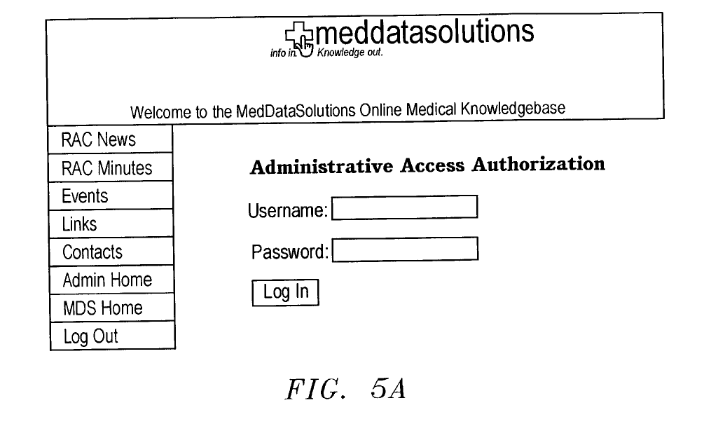

Referring to FIG. 4, a method 80 is performed by the server 6. The method 80 commences with a step 82 of receiving an accessing communication and serving up information, for example, a web page, to the device, for example, the provider device 8a, 8b which accesses the server 6. The server 6 communicates the web page or other information over the network 4 to the provider device 8a, 8b. The information is communicated over the network 4 according to the network 4 protocols, such as TCP/IP.

In a step 84, the server 6 receives data from the provider device 8a, 8b. The data received by the server 6 from the provider device 8a, 8b is the input made by the user of the provider device 8a, 8b. The input data is, for example, trauma data information. The data received by the server 6 from the provider device 8a, 8b in the step 84 is communicated over the network 4 to the server 6 and conforms to the network 4 protocols.

Once the data has been received in the step 84 by the server 6, the server 6, alone or in combination with other computer and communications devices (not shown in the Figures), performs a variety of steps with the data. As examples of the steps which may be performed with the data, the data may be stored by the server 6 in a step 86. The step 86 can include integration of the data in the server 6 database, as previously mentioned, and writing and saving the information to a computer hard drive, data warehouse, CD-ROM or other conventional storage mechanism.

In a step 88, the server 6 can, alone or in association with other computing devices, compile the data. The step of compiling 88 can include such activities as formatting the data, organizing the data, manipulating the data, which includes such activities as statistical analyses and accounting transactions, and other data compilation activities. Of course, those skilled in the art will readily know and understand that the step of compiling 88 the data will depend upon the desired result of information to be made available by the server 6 to devices in communication with the server 6 over the network 4.

In a step 90, the server 6 aggregates the data, including by sorting, cumulating, and further manipulating individual data from the provider devices 8a, 8b. As with the step 88, the step 90 and the particular relevant activities of the server 6 depend on the desired actions of the server 6, the information desired to be made available by the server 6, and the particular programming of the server 6 to achieve these objectives. Other activities of the server 6 that can be appropriate include preparation of reports 92 based on the data at the server 6 and the particular activities programmed at the server 6.

The steps 86, 88, 90, 92 are followed by a step 94 of submitting reports to a receiver device 10. The step 94 may be performed on demand, either initiated at the server 6 or by the receiver device 10, on a scheduled periodic basis, or under such other timing and conditions as the server 6 and the receiver device 10 coordinate. Although the step 94 is shown in FIG. 4 to follow immediately after the step 92, FIG. 4 includes a loop back to indicate that the steps 83 through 92 may be repeated numerous times prior to occurrence of the step 94. Furthermore, it is to be understood that, although a particular sequence of the steps 82-92 are shown in FIG. 4, this sequence can be varied with certain of the steps occurring simultaneously or in different order.

In a step 96, the server 6 serves up information over the network 4 to the receiver device 10. The step 96 is performed in response to the receiver device 10 performance of the method 60 (shown in FIG. 3). If the server 6 serves up information formatted as a web page, the receiver device 10 displays the web page and, additionally or alternatively, makes the information available to the agent device 12.

The receiver device 10 can also communicate with the server 6 in a step 98. In the step 98, information transmitted by the receiver device 10 is received by the server 6. This information so received in the step 98 is either control information or data that is maintained at the server 6. Control information can indicate to the server 6 that certain operations are to be performed by the server 6. Data information received by the server 6 can be requests, queries, input, and other information that the receiver device 10 is allowed to access at the server 6.

A step 100 indicates that the server 6 can also serve up information to the third party device 14. The third party device 14 can be a plurality of devices that are permitted to access information and provide control signals to the server 6. The information served to the third party device 14 by the server 6 in the step 100 can be a web page or other format. The particular information available to the third party device 14, will, as previously mentioned, be dictated at the server 6 and by the communications channels of the network 4.

### EXAMPLES

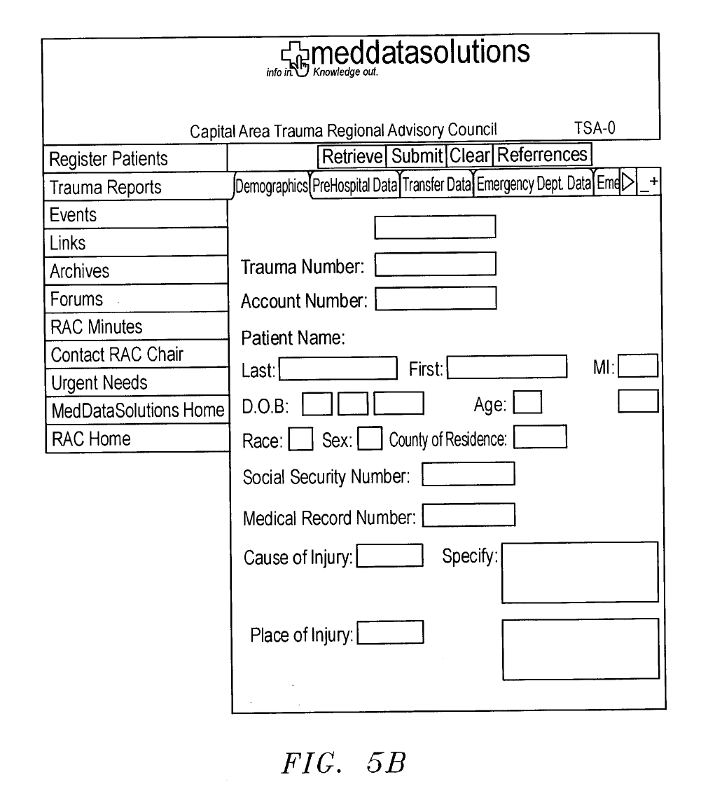

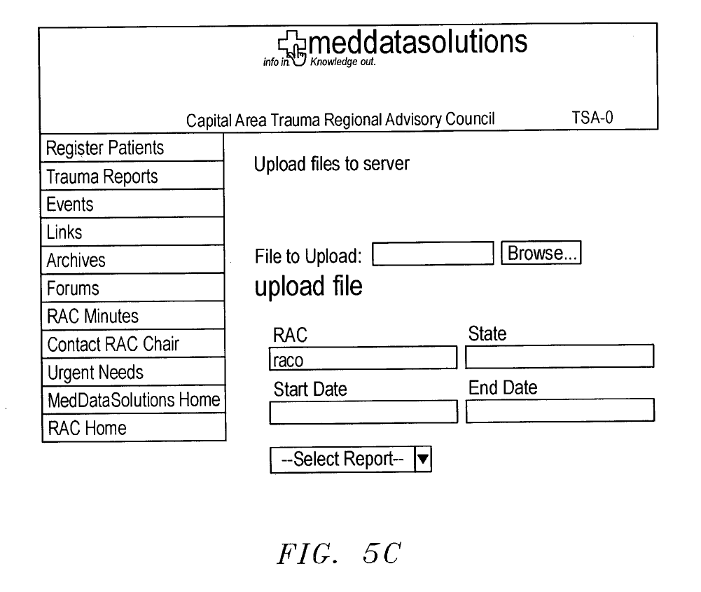

Exemplary communications over the network 4, by the server 6 with the provider devices 8a, 8b, the third party device 14, the receiver device 10, and, if applicable, the agent device 12, are web pages in FIGS. 5a-c. Referring to FIGS. 5a-b, in conjunction with FIGS. 1-2 and 4, when a provider device 8a, 8b accesses the server 6 over the network 4, the server 6 transmits to the provider device 8a, 8b for display at the provider device 8a, 8b a series of web pages of the automated data reporting system and method. Examples of the web pages include an access authorization page, such as shown in FIG. 5a; and an information input page, such as shown in FIG. 5b, to which a user of the provider device 8a, 8b can input health related data for maintenance in the database associated with the server 6. Referring to FIG. 5c, in conjunction with FIGS. 1 and 3-4, when a receiver device 10 accesses the server 6 over the network 4, the server 6 transmits to the receiver device 10 for display at the receiver device 10 a different web page of the automated data reporting system and method. In the instance of the server 6 providing reporting of the health related data submitted by the provider devices 8a, 8b, the web page accessed by the receiver device 10 allows input of a request for information regarding the health related data, such as the data itself, statistical analyses of the data, formatted cumulative reporting of the data, or similar information.

Embodiments of the present invention are particularly advantageous in applications of reporting of trauma data, by trauma healthcare providers (such as EMS, emergency room, and others), to state health agencies. In such applications, the server 6 is maintained to receive and collect trauma patient and care information from trauma care providers who communicate with the server 6 via the provider devices 8a, 8b. The receiver device 10 is operated, for example, by a state-organized entity (such as a Regional Advisory Council in the State of Texas), for receiving such information from trauma care providers. The receiver device 10, based on the information reported by the provider devices 8a, 8b, communicates all or portions of the information received by the receiver device 10 to the agent device 12. The agent device 12 is, for example, used by the state health authority. The third party device 14, when communicating with the server 6, has limited or restricted access to information at the server 6. For example, the information available to the third party device 14 can include portions or compilations of the trauma information, general public health information, and other possible content.

Although illustrative embodiments of the invention have been shown and described, a wide range of modification, change, and substitution is contemplated in the foregoing disclosure and in some instances, some features of the present invention may be employed without a corresponding use of the other features. Accordingly, it is appropriate that the appended claims be construed broadly and in a manner consistent with the scope of the invention.

What is claimed is:

1. A method for reporting health related data over a communication network, comprising the steps of:
accessing a server device of the communication network;
providing to a provider device a uniform format for entering the data;
receiving the data from the provider device;
and storing the data.

2. The method of claim 1, further comprising the step of:
compiling the data into a database; and
providing aggregate amounts of the health related data.

3. The method of claim 1, further comprising the step of:
providing secured access to the data via the communication network.

4. The method of claim 1, further comprising the step of:
preparing reports of the data; and
serving up the reports via the communication network to a device capable of receiving the reports over the communication network.

5. The method of claim 1, wherein the step of receiving the data comprises the steps of:
receiving a query from the provider device; and
serving to the provider device an interactive web page in response to the query from the provider device.

6. The method of claim 1, wherein each of the steps of providing, receiving, and storing are performed by the server device.

7. The method of claim 6, wherein said server device is remotely located from the provider device.

8. The method of claim 1, further comprising the step of:
reporting at least a portion of the data to a receiver device over the communication network, wherein the receiver device communicates with the server device over the communication network.

9. The method of claim 1, further comprising the steps of:
reporting at least a portion of the data to the provider device over the communication network, wherein the provider device communicates with the server device over the communication network.

10. The method of claim 1, wherein the step of storing the data formats the data as an Extensible Markup Language (XML) document.

11. The method of claim 1, wherein the communication network is selected from the group consisting of the Internet, an extranet, and an intranet.

12. A method for trauma data over a communication network, wherein the communication network is the Internet, comprising the steps of:
providing a database, wherein the database serves to relate queries with preprogrammed responses in the form of data entry forms and stores information entered into the data entry form;
delivering a query to the database over the communication network;
accessing an interactive graphical interface relevant to the queries;
inputting data; and
storing the data in the database.

13. The method of claim 12, further comprising the step of:
displaying a graphical interface to the database for access over the network, wherein the graphical interface is viewed in the step of accessing and the data is input into the graphical interface in the step of inputting.

14. The method of claim 12, wherein the step of delivering, on the one hand, and the step of accessing and inputting, on the other hand, are performed at geographically remote locations on the communication network.

15. The method of claim 12, wherein the step of delivering is performed via a static Hypertext Markup Language page; and
further comprising the step of generating a dynamic Hypertext Markup Language page based on the queries from the static Hypertext Markup Language page.

16. The method of claim 12, wherein the steps of providing and storing are performed by a server computer; the step of delivering is performed by a device selected from the group consisting of: a provider device, a receiver device, a third party device, and any combination of the devices.

17. The method of claim 12, wherein the steps of accessing and inputting are performed by a device selected from the group consisting of: a provider device, a receiver device, a third party device, and any combination of the devices.

18. The method of claim 12, wherein the provider device, the receiver device, and the third party device are each computers.

19. The method of claim 12, wherein the communication network is selected from the group consisting of: the Internet, an extranet, and an intranet.

20. A system for the collection, storage, analysis, and reporting of health related data, comprising:
a processor;
a memory device coupled to the processor;
a communication device coupled to the processor and the memory device, that enables communication via the communication network;
a relational database that is stored and updated in the memory device; and
an application program that is executed by the processor from the memory device comprising:
first code, responsive to a query from a provider device via the communication device that instructs the communication device to send a data entry form to the provider device;
second code, responsive to receiving a completed data entry form from the provider device, that stores data from the data entry form into the database;
third code, responsive to receiving the completed data entry form from the provider device, that notifies healthcare provider communication device of errors; and
fourth code that instructs said communication device to transmit a summary of said data to a receiving agency.

21. The system of claim 20, the application program further comprising:
fifth code, responsive to a query from a third party communication device via said communication device that instructs said communication device to send a data entry form to the third party communication device; and
sixth code, responsive to receiving a data entry form back from the third party communication device via said communication device that stores information submitted by the third party communication device;
seventh code, responsive to receiving data back from the third party communication device that notifies the third party communication device of any errors; and
eighth code that instructs said communication device to transmit a summary of said data to a receiving agency.

22. The system of claim 21, the application program further comprising:
ninth code, responsive to a query from a receiving agency communication device via said communication device to send a data entry form to the receiving agency communication device;
tenth code, responsive to receiving a data entry form back from the receiving agency communication device via said communication device that stores information submitted by the receiving agency communication device; and
eleventh code, responsive to receiving a data entry form back from the receiving agency communication device that notifies the receiving agency of errors.
